(19) United States
(12) Patent Application Publication
(10) Pub. No.: US 2013/0048896 A1
(43) Pub. Date: Feb. 28, 2013

(54) PISTON VALVE

(71) Applicant: Yuval Stern, Ramot Meir (IL)

(72) Inventor: Yuval Stern, Ramot Meir (IL)

(21) Appl. No.: 13/596,459

(22) Filed: Aug. 28, 2012

Related U.S. Application Data
(60) Provisional application No. 61/529,407, filed on Aug. 31, 2011.

(51) Int. Cl. F16K 1/00

(52) U.S. Cl. 251/324

(57) ABSTRACT

A piston-type flush valve comprises a housing configured with a fluid inlet port and a fluid outlet port being in flow communication with one another through a flow port, and a piston assembly axially displaceable between a normally closed position in which the flow port is sealed, and an open position. The piston assembly comprises a control chamber which responsive to pressure differential is configured for displacing a sealing assembly from an open position in which fluid flow is facilitated through the flow port, into the normally closed position, and an actuator configured for selectively draining the control chamber into the fluid outlet port, resulting in displacement of the piston assembly into the open position. The control chamber is sealed from the fluid inlet port by a control chamber seal, sealingly displaceable against an anti-friction sleeve articulated to the housing.

### FIELD OF THE DISCLOSED SUBJECT MATTER

This invention relates to piston-type valves and more particularly it is concerned with such piston-type valves referred to as flush valves and configured for rapid discharging a large amount of fluid and shutting thereafter.

### BACKGROUND OF THE DISCLOSED SUBJECT MATTER

Piston-type valves are well known. Such valves are often used in conjunction with sanitary equipment e.g. toilet bowls, urinal, automated wash basins and the like, and are often referred to as flush valves, are configured for discharging a preset amount of water upon initiating by a manual or automatic signal, i.e. activating by a user, a presence sensor, a timer, etc.

Piston-type flush valves are disclosed, for example in U.S. Pat. No. 8,069,877 directed to a flush valve including a pressure compensating device for toilet and urinals to ensure consistent flush and bowl refill volumes. Certain flush volume limits may required for compliance with federal, state and local regulations regarding water usage. The flush valve can adjust water flow rates within the prescribed water usage limits and does not sacrifice the toilet's bowl washing and waste removal capabilities.

U.S. Pat. No. 7,028,975 discloses a flush valve structure to control flush water through a pressure difference mainly includes a case, a solenoid assembly, an upper intermediate board, a lower intermediate board and a main water ball. The upper intermediate board has a small water pressure release hole. The lower intermediate board has a holding trough mating a medium water valve. The solenoid assembly can open the small water pressure release hole to generate a pressure difference to actuate the medium water valve to form a greater pressure difference so that the main water ball is lifted rapidly to fully open the a main water discharge opening to flush maximum amount of water in a shortest period at the flushing start time.

### SUMMARY OF THE DISCLOSED SUBJECT MATTER

A piston-type flush valve is used for effectively discharging a substantially fixed, predetermined amount of fluid within a relative short time, and sealingly shutting upon said discharge. Such valves are used, by way of example, in conjunction with sanitary equipment, e.g. toilet bowls, urinals, automatic hand washing faucets, etc,.

According to the disclosed subject mater there is provided piston-type flush valve comprises a housing configured with a fluid inlet port and a fluid outlet port being in flow communication with one another through a flow port, and a piston assembly axially displaceable between a normally closed position in which the flow port is sealed, and an open position; said piston assembly comprising a control chamber which responsive to pressure differential is configured for displacing a sealing assembly from an open position in which fluid flow is facilitated through the flow port, into the normally closed position; and an actuator configured for selectively draining the control chamber into the fluid outlet port, resulting in displacement of the piston assembly into the open position; said control chamber being sealed from the fluid inlet port by a control chamber seal, sealingly displaceable against an anti-friction sleeve articulated to the housing.

According to a particular design of the disclosed piston-type flush valve, the sealing assembly is articulated with the control chamber seal and is axially displaceable responsible to pressure differential within the control chamber, between the closed position in which a flow port seal articulated to the sealing assembly sealingly engages the flow port and wherein fluid flow is prevented, and an open position wherein the sealing assembly is contracted and the flow port is open.

At the closed position the control chamber is pressurized by fluid entailing axial displacement of the sealing assembly into the closed potion, and at the open position the control chamber is drained.

The piston assembly comprises a fluid bleed port extending between the fluid inlet port and the control chamber for pressure build-up within the control chamber after the valve has been momentarily opened for a flushing operation, and whereby said pressure build-up entails displacement of sealing assembly into its closed position.

The housing is further configured with an actuator chamber being in flow communication with the control chamber via an actuator inlet passage, and an actuator outlet port being in flow communication with the outlet port via a drain port and is normally sealed by the actuator plunger of said actuator.

According to another aspect of the present disclosed subject matter there is a provided a housing for a flush valve of the specified type, said housing configured with an anti-friction sleeve articulated to the housing for sealing engagement with control chamber seal sealingly displaceable against said anti-friction sleeve, whereby said control chamber is sealed from the fluid inlet port.

According to the disclosed subject matter there is provided piston-type flush valve comprises a housing configured with a fluid inlet port and a fluid outlet port being in flow communication with one another through a flow port, and a piston assembly axially displaceable between a normally closed position in which the flow port is sealed, and an open position; said piston assembly comprising a control chamber which responsive to pressure differential is configured for displacing a sealing assembly from an open position in which fluid flow is facilitated through the flow port, into the normally closed position; and an actuator configured for selectively draining the control chamber into the fluid outlet port, resulting in displacement of the piston assembly into the open position; said control chamber being sealed from the fluid inlet port by a control chamber seal sealingly displaceable against an anti-friction sleeve articulated to the housing.

Any one or more of the following features and designs can be incorporated in a piston-type flush valve according to the disclosed subject mater, separately or in combination:
The housing can be made of injected plastic material;
The anti-friction sleeve can be integrated within the housing by an over-molding process;
The anti-friction sleeve is made of wear-resistant material, e.g. ceramics, metal, etc.;
The control chamber seal can be for example an O-ring. According to one example the control chamber seal is a U-shaped seal, having one arm thereof secured to the piston assembly and another arm biased for sliding engagement against the anti-friction sleeve.
According to a particular design the control chamber seal is a hydraulic seal being in flow communication with the fluid inlet port;
The actuator plunger is articulated to a operator configured for displacing the actuator plunger between a retracted position and a projecting position; the operator can be a solenoid, a hydraulic actuator, a mechanical actuator, etc.;
A primary bleed port extends between the inlet port and a fluid accumulating duct, and the fluid bleed port extends from the fluid accumulating duct to the control chamber;
An override actuator valve can be provided in the housing for forcing the piston valve to open by facilitating displacement of the piston assembly into its open position. Said override actuator valve can be an electric or a mechanical override, which upon activation thereof opens a fluid flow path between the control chamber and the outlet port, thus resulting in pressure drop at the control chamber and thereby opening the valve;
The fluid bleed port comprises a self-cleaning mechanism in the form of a vibrating needle extending through a restricted-aperture port, thereby governing fluid bleed rate from the fluid inlet port into the control chamber;
The cross-sectional area of the actuator inlet port (Aᵢₚ) is smaller than the cross-sectional area of the actuator outlet port (Aₒₚ), and the cross-sectional area of the drain port (A_{dp}) is greater than that of the actuator outlet port (Aₒₚ) [Aᵢₚ<Aₒₚ; A_{dp}>>Aₒₚ];
The fluid inlet port and the fluid outlet port can extend coaxially or they can be configured at any deferent arrangements, e.g. at a right angle, or inclined with respect to one another, etc.

### BRIEF DESCRIPTION OF THE DRAWINGS

In order to understand the disclosed subject matter and to see how it may be carried out in practice, embodiments will now be described, by way of a non-limiting example only, with reference to the accompanying drawings, in which:

FIG. 1A is an overall isometric view of the flush valve according to the present disclosed subject matter

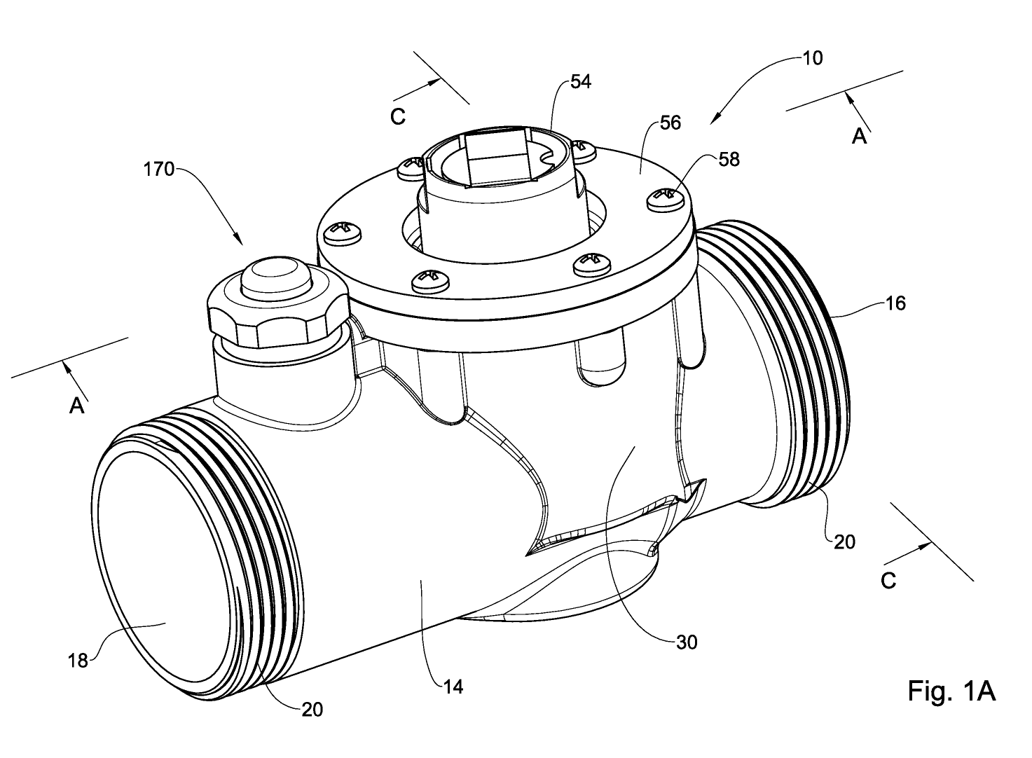

FIG. 1B is front view of FIG. 1A;

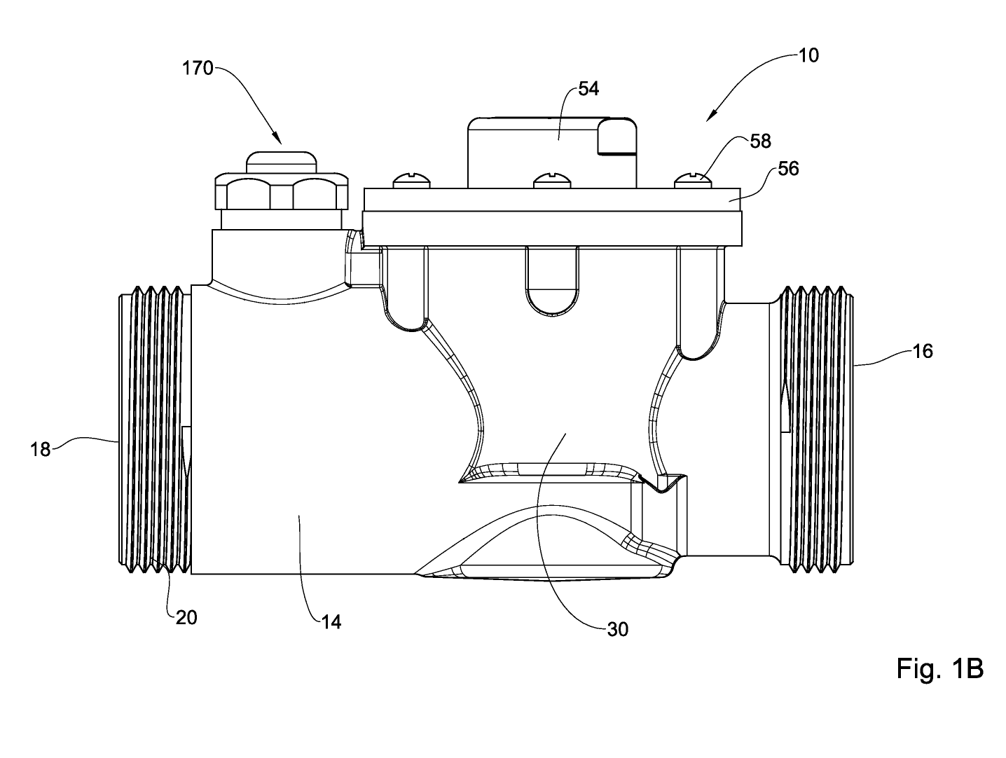

FIG. 1C is a longitudinal cross section of the valve of FIG. 1B, showing only the valve housing, however with a friction sleeve fitted therein;

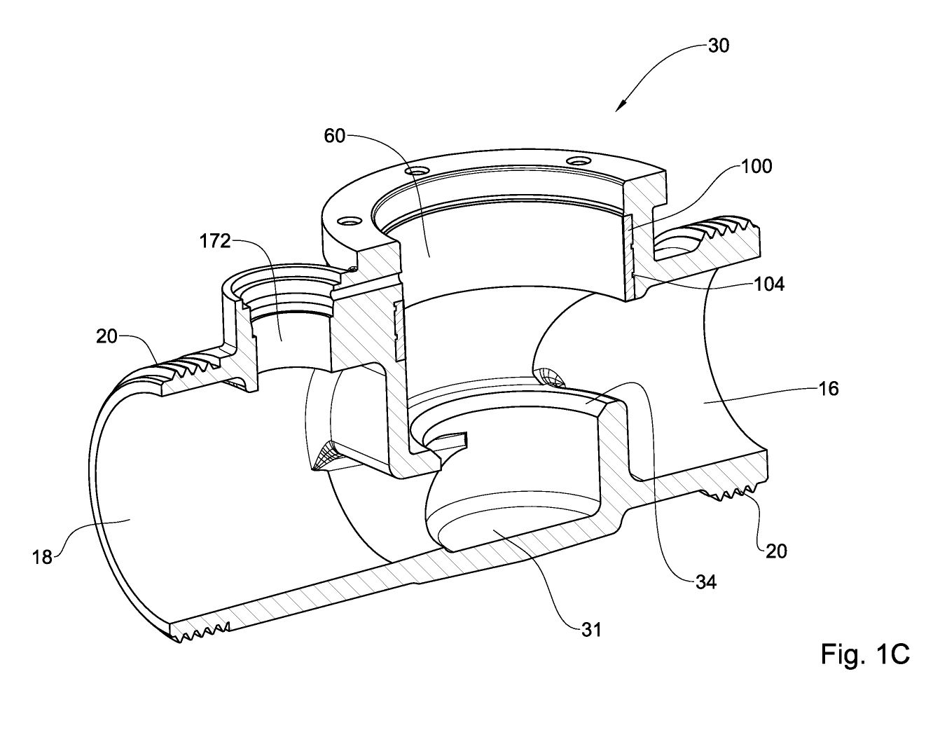

FIG. 2A is a longitudinal section along line A-A in FIG. 1A, the flush valve at its normally closed position;

FIG. 2B is a longitudinal cross section of the valve of FIG. 1B, the flush valve at its normally closed position;

FIG. 2C is longitudinal section along line C-C in FIG. 1A, the flush valve at its normally closed position;

FIG. 2D is an enlargement of the portion marked D in FIG. 2A;

FIG. 2E is an enlargement of the portion marked D in FIG. 2A, however at the instance of manipulating an activator;

FIG. 3A is a longitudinal section along line A-A in FIG. 1A, the flush valve at its open position;

FIG. 3B is an enlargement of the portion marked D in FIG. 2A, however with the valve at its closed position; and

FIG. 4 is an enlarged view of the piston assembly at the closed position.

### DETAILED DESCRIPTION OF EMBODIMENTS

Attention is directed to the annex drawings for understanding the structure and operation of the piston type flush valve according to the presently disclosed subject matter and generally designated 10. The valve 10 comprises a housing 14 configured with a fluid inlet port 16 and a fluid outlet port 18.

It is pointed out that while in the present example the fluid inlet port 16 and a fluid outlet port 18 extend coaxially, they can be configured at any deferent arrangements, e.g. at a right angle, or inclined with respect to one another, etc.

In the present example the fluid inlet port 16 and a fluid outlet port 18 are coaxial and are externally threaded at 20 for coupling to a respective fluid inlet line (not shown) and a fluid outlet line (not shown). For example, the valve 10 may be used in conjunction with a sanitary device (not shown; e.g. toilet bowl, wash basin, urinal etc, wherein the fluid inlet port 16 is coupled to a water supply and the fluid outlet port 18 is coupled to the sanitary device.

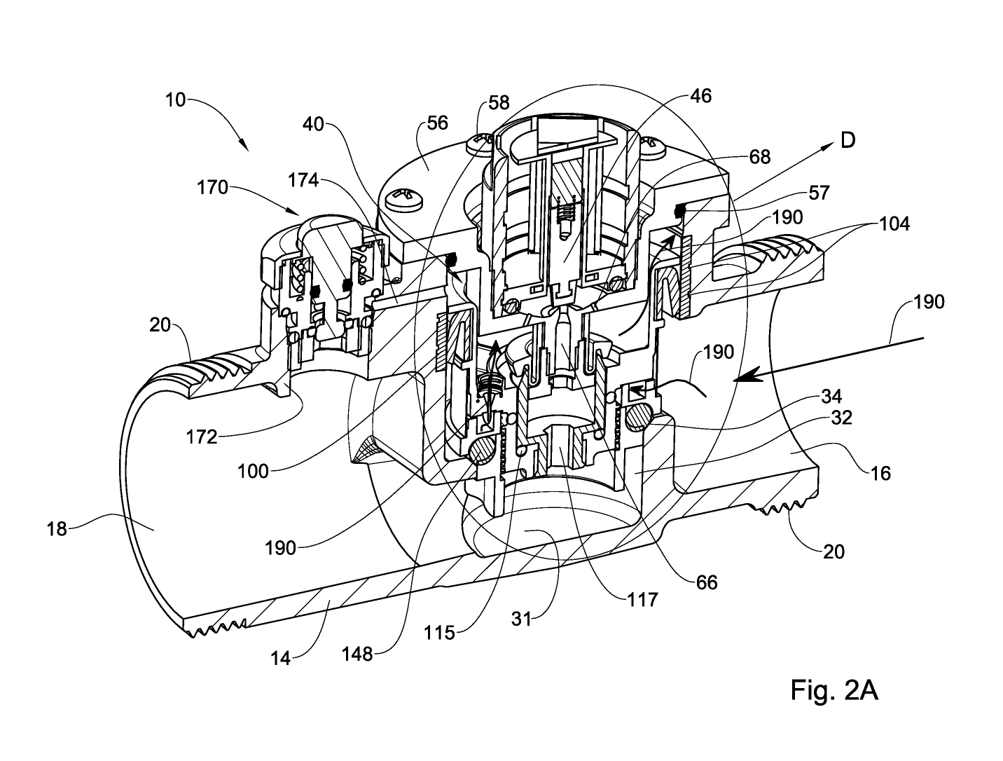

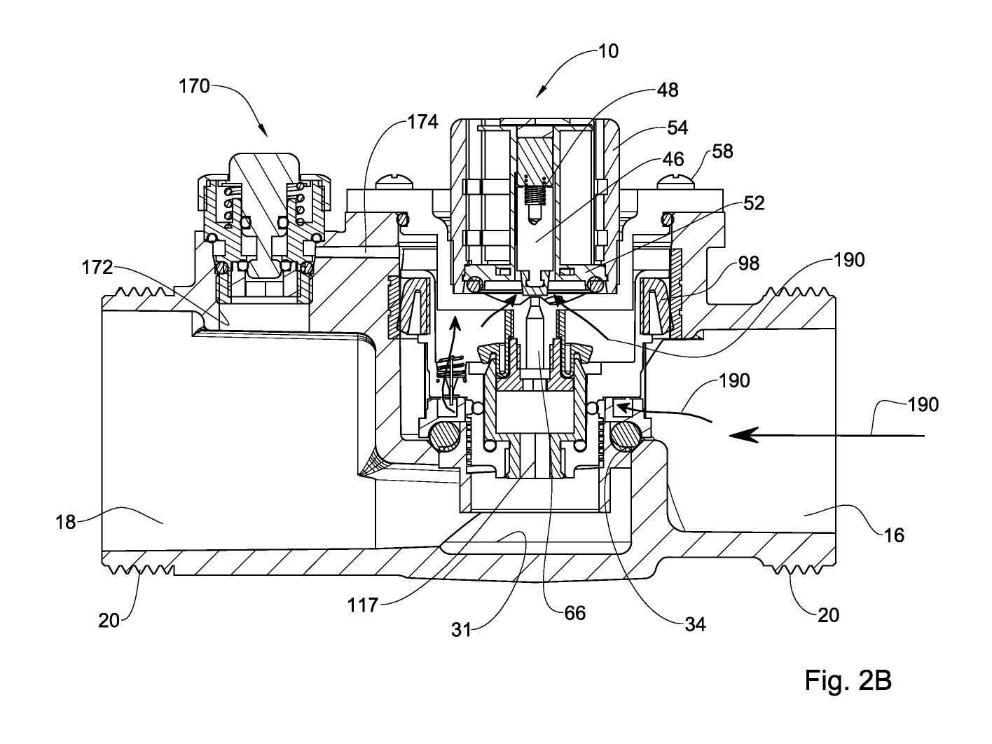

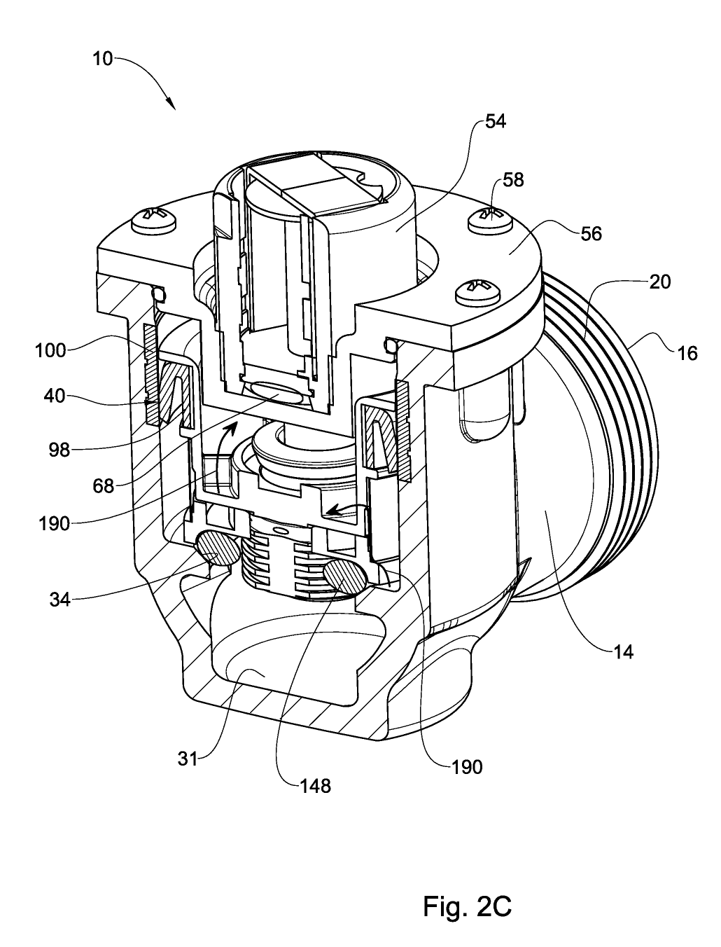

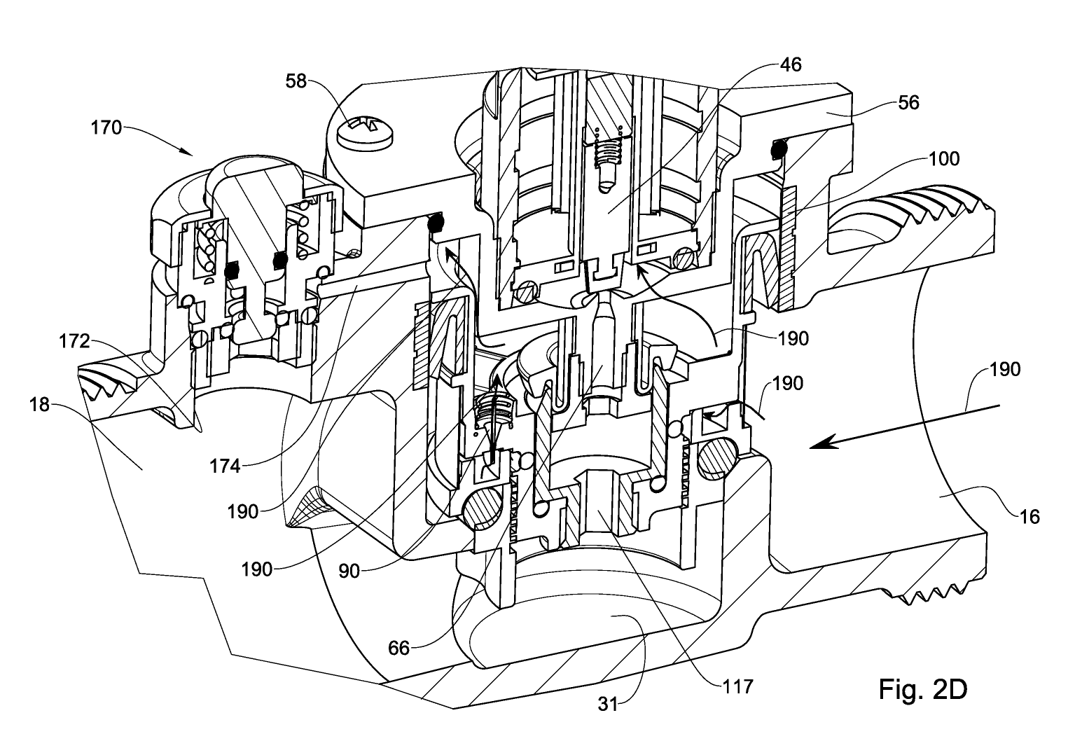

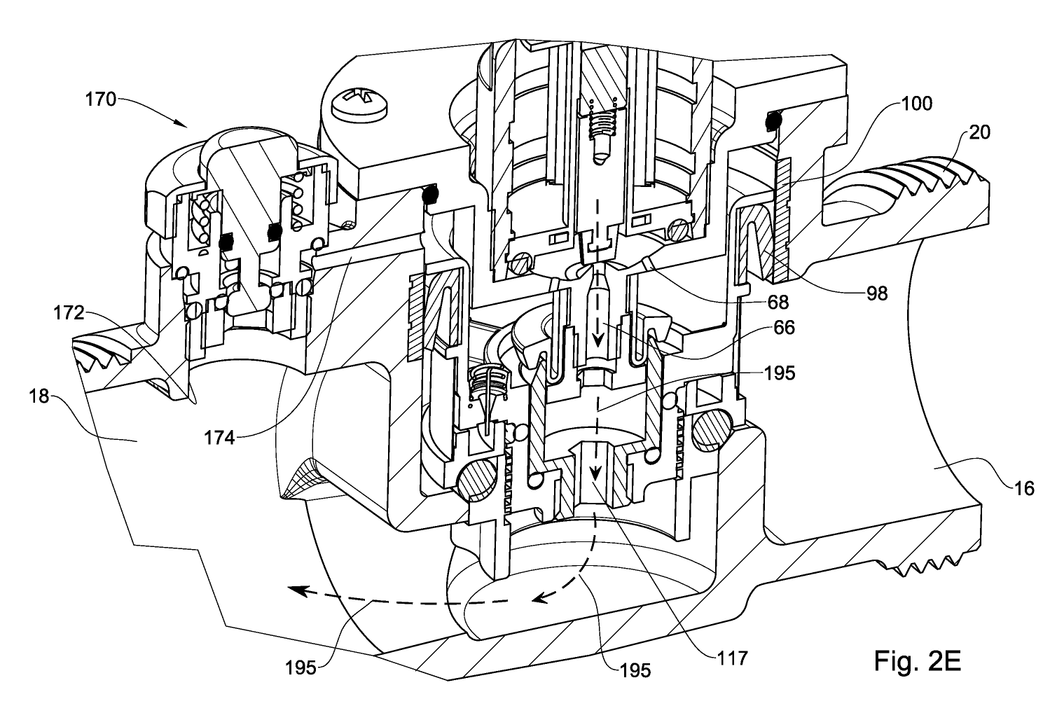

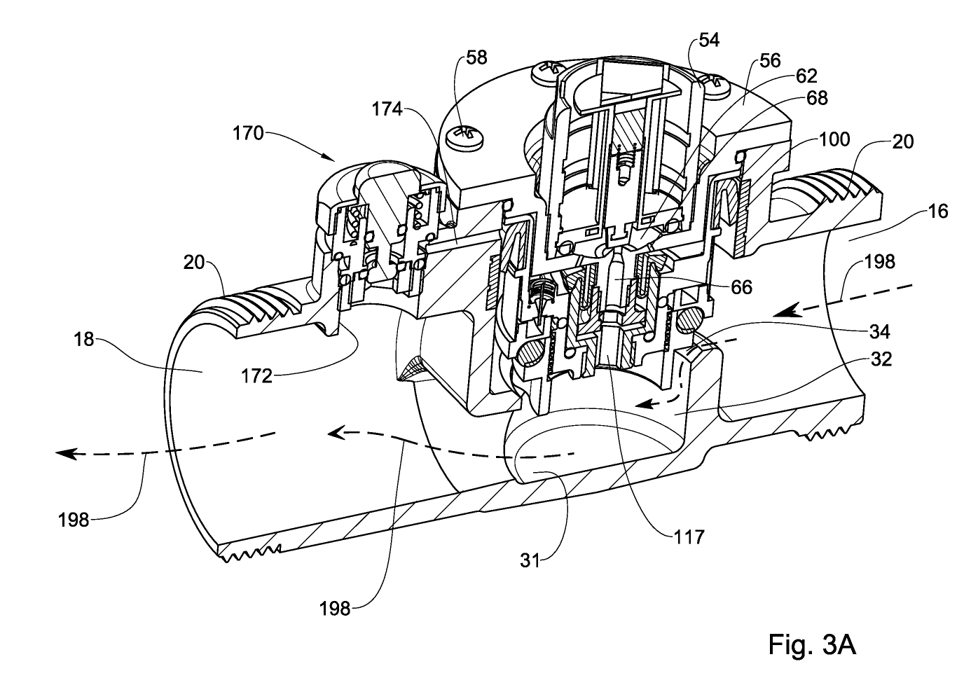

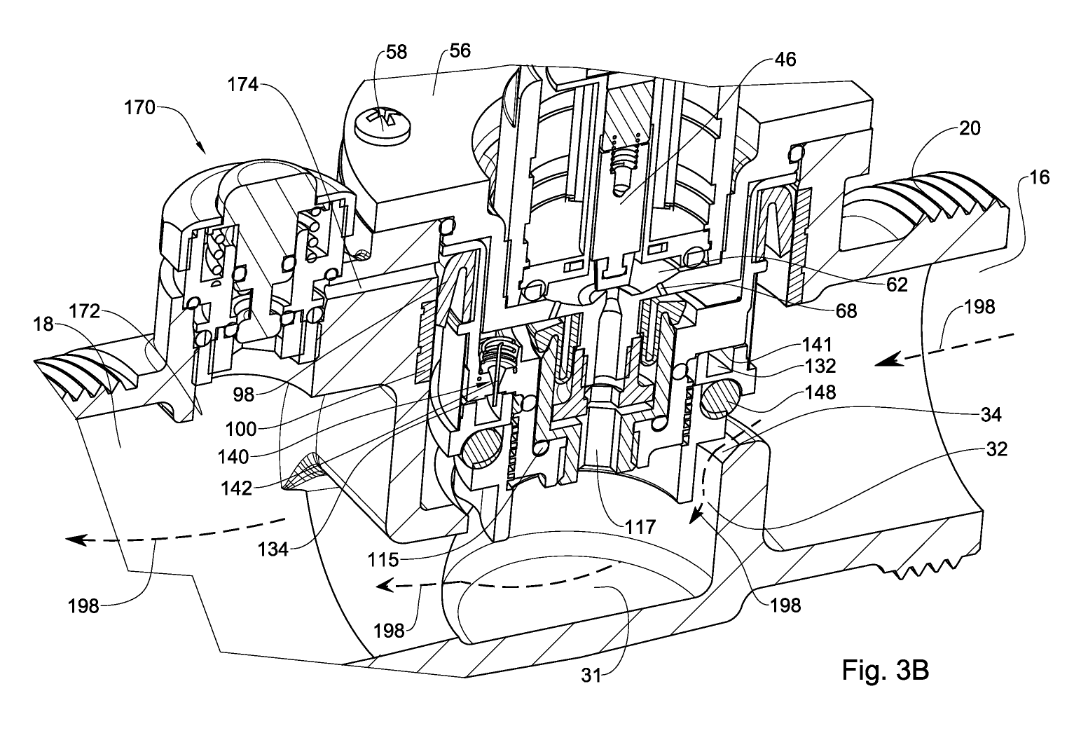

Interposed between the fluid inlet port 16 and the fluid outlet port 18 the housing 14 is configured with an actuating portion 30, which as can be seen in the sectioned views of FIGS. 2 and 3 said portion is configured with a flow port 32 configured with a circular sealing seat 34, whereby the fluid inlet port 16 and the fluid outlet port 18 are in flow communication with one another via said flow port 32.

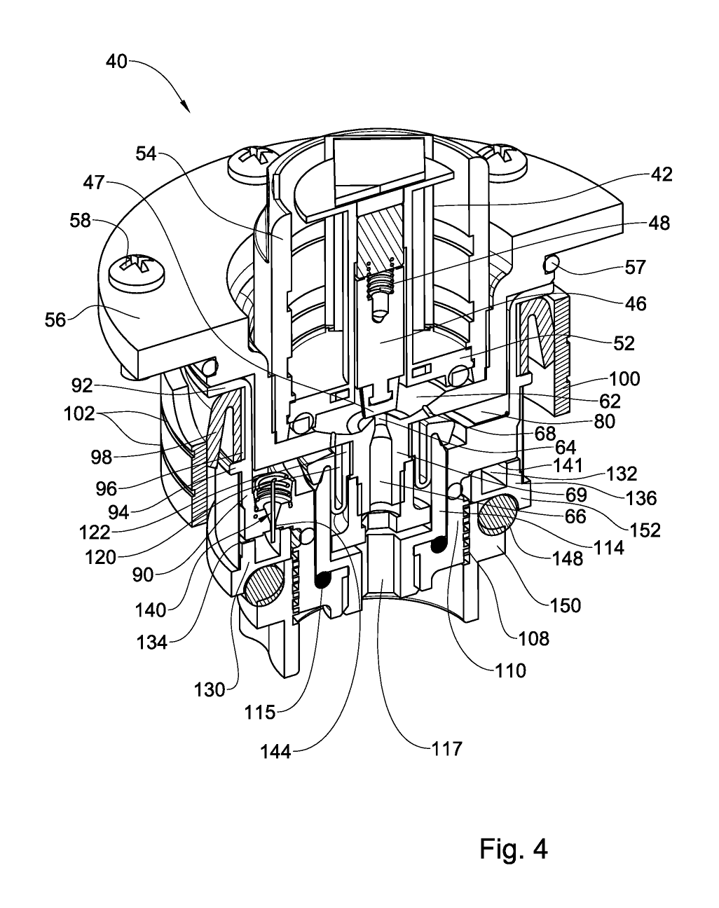

A piston assembly generally designated 40 (seen in FIG. 4 isolated from the valve housing) comprises an actuator 42 (which in the illustrated example is a solenoid) configured with an actuator plunger 46, fitted with a resilient sealing tip 47 and loaded by a coiled spring 48, and a sealing member 52 sealingly enveloping the actuator components. The actuator 42 is received within a capsule-like housing 54 secured to a flanged actuator seat 56 which in turn is screw coupled by screws 58 within an opening 60 of the actuating portion of the 30 the housing 14. It is seen that the actuator seat 56 is fitted with an O-ring 57 sealing against the inner wall of the opening 60 of housing 14.

The actuator seat 56 is a cylindrical member with a basin 62 configured below the actuator 42 such that actuator plunger 46 coaxially extends over an actuator outlet port (Aₒₚ) 64, extending into a drain port (A_{dp}) 66 within a drain extension segment 69, which as will be explained hereinafter is in flow communication with a basin portion 31 of the housing 14 which in turn is in flow communication with the fluid outlet port 16. The basin 62 is further configured with one or more actuator inlet ports (Aᵢₚ) 68 which as will be explained hereinafter give rise to flow communication between the basin 62 and a control chamber 80 of the piston assembly 40. The arrangement is such that cross-sectional area of the actuator inlet port (Aᵢₚ) is smaller than the cross-sectional area of the actuator outlet port (Aₒₚ) i.e. Aᵢₚ<Aₒₚ, and the cross-sectional area of the drain port (A_{dp}) is greater than that of the actuator outlet port (Aₒₚ) i.e. A_{dp}>>Aₒₚ.

The piston assembly 40 further comprises, a piston housing 90 extending below the actuator seat 56, said piston housing configured with an outwardly projecting flanged top wall 92 and an annular rim 94 extending below, forming together a seal housing space designated 96 and accommodating a control chamber seal 98. In the present example the seal 98 is an inverted U-like seal made of resilient material, though it is appreciated that other forms of seals can be used, e.g. O-rings, hydraulic seals and the like.

The control chamber seal 98 is configured for sealingly sliding against an anti-friction sleeve 100 secured within the opening 60 of housing 14. It is seen that the anti-friction sleeve 100 is configured with retention grooves 102 arrested by corresponding rims 104 extending from the wall of the opening 60, for positioning and fixedly arresting the anti-friction sleeve 100. It is however appreciated that the anti-friction sleeve 100 can be an insert configured for retrofit within the housing 14, or the housing can be molded over the anti-friction sleeve in a non-removal fashion.

Whilst the housing is typically made of a molded material, e.g. plastic or metal, and as such the inner wall of the opening 60 is relatively rough/coarse, the anti-friction sleeve is made of a material offering smooth surface quality and friction resistant material, and as such can be made of any suitable material e.g. ceramics, bronze, steel, etc.

The piston housing 90 is articulated (e.g. by screw coupling at 108) with a seal support member 110 such that they are fixed together. The seal support member 110 is configured with a central cup-like portion 114 coaxially extending within the piston housing 90 and over the drain extension segment 69 downwardly extending from the actuator seat 56. Noted, the cup-like portion 114 is sealingly received within the seal support member 110 with an O-ring 115 provided therebetween. A flow passage 117 extends through the seal support member 110, being in flow communication with the drain port (A_{dp}) 66 within a drain extension segment 69 and further with the basin portion 31 and the fluid outlet port 18.

A resilient U-shaped sealing sleeve 120 is secured within the cup-like portion 114 of the seal support member 110, configured such that one leg portion 122 is sealingly retained and secured against the drain extension segment 69, and another leg portion of the seal 120 is sealingly retained and secured at a top of the cup-like portion 114. This arrangement facilitates axial displacement of the articulated piston housing 90 and seal support member 110 with respect to the actuator seat 56, however at a sealed configuration.

Clamped between the seal support member 110 and the cup-like portion 114 there is a ring shaped member 130 configured with an annular groove constituting a fluid accumulating duct 132, the arrangement being such that a narrow gap 134 extends between the outer wall 136 and a bottom surface 141 of the piston housing 90, said gap serving as a primary bleed port between the fluid inlet port 16 and the annular groove 132, the purpose of which to become apparent hereinafter.

As can further be seen, the piston housing 90 is configured with fluid bleed port 130 extending between the fluid accumulating duct 132 and the control chamber 180, said fluid bleed port 140 is cited with a self-cleaning mechanism in the form of a vibrating needle 142 extending through a restricted-aperture aperture 144, thereby governing fluid bleed rate from the fluid accumulating duct 132 and respectively from the fluid inlet port 16, into the control chamber 80.

As can be seen, a flow port sealing O-ring 148 is secured between a lateral support seat 150 of the seal support member 110 and a downward facing support rim 152 of the ring shaped member 130, whereby the flow port sealing O-ring 148 is tightly secured with only a portion thereof being exposed for sealing engagement with the circular sealing seat 34 of the flow port 32 of the housing 14.

Further noted, the valve 10 is configured with an override actuator valve generally designated 170 and retained within an opening 172 within housing 14, for forcing the piston valve to open by facilitating displacement of the piston assembly into its open position. Said override actuator valve 170 can be an electric or a mechanical override, which upon activation thereof opens a fluid flow path 174 formed in the housing 14 between the control chamber 80 and the outlet port 18. Operation of the override valve 170 will become apparent hereinafter.

In use, the flush valve 10 disclosed hereinabove operates as follows.

At the normally closed position of the valve 10 (FIGS. 2), the piston assembly 40 is at its respective closed position whereby the flow port sealing O-ring 148 sealingly bears against the sealing seat 34 of the flow path 32, thereby preventing fluid flow (e.g. water) between the fluid inlet port 14 and the downstream fluid outlet port 18. This position is static and will remain so until the valve is manipulated into its open position.

Instantaneously after opening the valve (e.g. a flushing operation) the valve closes into the position disclosed hereinabove, whereby downstream liquid from the inlet port 14 flows through gap 134 into the fluid accumulating duct 132 and respectively through bleed port 140 into the control chamber 80, and then through actuator inlet ports (Aᵢₚ) 68 into the basin 62, as represented by arrowed lines 190. At this stage discharge of the liquid from the control chamber is prevented.

Once the actuator 42 is manipulated, e.g. upon pressing a knob or activating a proximity sensor or an IR sensor or the like, the plunger 46 retracts thereby opening the flow passage through actuator outlet port (Aₒₚ) 64 into the drain port (A_{dp}) 66, through the flow passage 117 of the seal support member 110 and out through the basin portion 31 and the fluid outlet port 18, as illustrated by dashed lines 195 (FIG. 3E). This gives rise to instant pressure decrease within the control chamber 80.

The pressure residing at the inlet port 14 is now higher than that at the control chamber and further, the total cross-section area acting on control chamber components from below is greater than that acting from above, resulting in displacement of the piston housing 90, with the components articulated thereto, into the open position, i.e. the flow port sealing O-ring 148 disengages from the sealing port 34, giving rise to opening the flow port 32, facilitating fluid flow from the fluid inlet port 16, through the flow port 32 and out to the fluid outlet port 18, as represented by dash-dotted lines 198 (FIG. 3).

Instantaneously after opening the valve (e.g. a flushing operation) the valve closes into the position disclosed hereinabove, whereby downstream liquid from the inlet port 14 flows through gap 134 into the fluid accumulating duct 132 and respectively through bleed port 140 into the control chamber 80, and then through actuator inlet ports (Aᵢₚ) 68 into the basin 62, as represented by arrowed lines 190. At this stage discharge of the liquid from the control chamber is prevented.

At the event of malfunction of the actuator 42 or for example upon exhaustion of batteries, a problem occurring with an associated sensor or electric wiring, or a mechanical fault, the valve assembly 10 may still be operated by activation thereof using the override actuator valve 170, upon which fluid flow path 175 opens, giving rise to fluid discharge and flow from the control chamber 80 directly to the outlet port 18, resulting in pressure drop at the control chamber, which in turn will facilitate displacing of the valve into the open position as discussed hereinabove.

1. A piston-type flush valve comprises a housing configured with a fluid inlet port and a fluid outlet port being in flow communication with one another through a flow port, and a piston assembly axially displaceable between a normally closed position in which the flow port is sealed, and an open position; said piston assembly comprising a control chamber which responsive to pressure differential is configured for displacing a sealing assembly from an open position in which fluid flow is facilitated through the flow port, into the normally closed position; and an actuator configured for selectively draining the control chamber into the fluid outlet port, resulting in displacement of the piston assembly into the open position; said control chamber being sealed from the fluid inlet port by a control chamber seal, sealingly displaceable against an anti-friction sleeve articulated to the housing.

2. A piston-type flush valve according to claim 1, wherein the sealing assembly is articulated with the control chamber seal and is axially displaceable responsible to pressure differential within the control chamber, between the closed position in which a flow port seal articulated to the sealing assembly sealingly engages the flow port and wherein fluid flow is prevented, and an open position wherein the sealing assembly is contracted and the flow port is open.

3. A piston-type flush valve according to claim 1, wherein at the closed position the control chamber is pressurized by fluid entailing axial displacement of the sealing assembly into the closed potion, and at the open position the control chamber is drained.

4. A piston-type flush valve according to claim 1, wherein the piston assembly comprises a fluid bleed port extending between the fluid inlet port and the control chamber for pressure build-up within the control chamber after the valve has been momentarily opened for a flushing operation, and whereby said pressure build-up entails displacement of sealing assembly into its closed position.

5. A piston-type flush valve according to claim 1, wherein the housing is further configured with an actuator chamber being in flow communication with the control chamber via an actuator inlet passage, and an actuator outlet port being in flow communication with the outlet port via a drain port and is normally sealed by the actuator plunger of said actuator.

6. A piston-type flush valve according to claim 1, wherein the control chamber seal is a U-shaped seal, having one arm thereof secured to the piston assembly and another arm biased for sliding engagement against the anti-friction sleeve.

7. A piston-type flush valve according to claim 1, wherein the control chamber seal is a hydraulic seal being in flow communication with the fluid inlet port.

8. A piston-type flush valve according to claim 5, wherein the actuator plunger is articulated to an operator configured for displacing the actuator plunger between a retracted position and a projecting position.

9. A piston-type flush valve according to claim 1, wherein a primary bleed port extends between the inlet port and a fluid accumulating duct, and the fluid bleed port extends from the fluid accumulating duct to the control chamber.

10. A piston-type flush valve according to claim 1, wherein an override actuator valve is provided in the housing for forcing the piston valve to open by facilitating displacement of the piston assembly into its open position, said override actuator valve is configured fir opening a fluid flow path between the control chamber and the outlet port, thus resulting in pressure drop at the control chamber and thereby opening the valve.

11. A piston-type flush valve according to claim 9, wherein the fluid bleed port comprises a self-cleaning mechanism in the form of a vibrating needle extending through a restricted-aperture port, thereby governing fluid bleed rate from the fluid inlet port into the control chamber.

12. A piston-type flush valve according to claim 5, wherein the cross-sectional area of the actuator inlet port is smaller than the cross-sectional area of the actuator outlet port, and the cross-sectional area of the drain port is greater than that of the actuator outlet port.

13. A piston-type flush valve according to claim 1, wherein the housing is made of injected plastic material.

14. A piston-type flush valve according to claim 1, wherein the anti-friction sleeve is integrated within the housing by an over-molding process.

15. A piston-type flush valve according to claim 1, wherein the anti-friction sleeve is made of wear-resistant material.

16. A housing for a flush valve according to claim 1, said housing configured with an anti-friction sleeve articulated to the housing for sealing engagement with a control chamber seal, sealingly displaceable against said anti-friction sleeve.

17. A housing according to claim 13, wherein the control chamber is sealed from the fluid inlet port.
